(19) United States
(12) Patent Application Publication
(10) Pub. No.: US 2013/0294809 A1
(43) Pub. Date: Nov. 7, 2013

(54) EYEGLASS CLEANING DEVICE

(71) Applicants: Phillip S. Eggers, Plano, TX (US); Matthew M. Sanderson, Dallas, TX (US)

(72) Inventors: Phillip S. Eggers, Plano, TX (US); Matthew M. Sanderson, Dallas, TX (US)

(21) Appl. No.: 13/463,713

(22) Filed: May 3, 2012

(51) Int. Cl. G02C 13/00; B05C 17/00

(52) U.S. Cl. 401/6; 401/261; 401/190; 401/188 R

(57) ABSTRACT

A cleaning utensil comprising a body having a first end, a second end and an interior cavity. A cap secured to the first end of the body and forming a water-tight seal against the body. A nozzle disposed on the cap, wherein the nozzle is configured to dispense a fluid that is stored in the interior cavity of the body. A grip attached to the second end of the body. A fabric head attached to the grip, the fabric heading including a mechanism to secure a fabric layer to the fabric head.

### TECHNICAL FIELD

The present disclosure relates to eyewear, and more specifically to a self-contained eyeglass cleaning device that includes a cleaning fluid and fabric material.

### BACKGROUND OF THE INVENTION

Many people wear eyeglasses, which can become dirty or soiled. Typically, a user will wipe their eyeglasses on a conveniently-located fabric material, but many materials are harmful to different types of eyeglass materials. For example, paper towels or facial tissues can scratch the surface of the eyeglasses, and clothing can have embedded dirt of fabric softener that can smudge or smear the surface. In addition, some types of dirt on eyeglasses may simply be smeared across the surface of the lens if a dry cloth is used without a cleaning fluid, but users often do not have ready access to a source of cleaning fluids.

### SUMMARY OF THE INVENTION

A cleaning utensil is provided that includes a body having a first end, a second end and an interior cavity. A cap is secured to the first end of the body and forms a water-tight seal against the body. A nozzle is disposed on the cap, where the nozzle dispenses a mist from a cleaning fluid reservoir stored in the interior cavity of the body. A grip is attached to the second end of the body, and a fabric head is attached to the grip, where the fabric head includes a mechanism to secure a fabric layer to the fabric head.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a cleaning utensil in accordance with an exemplary embodiment of the present disclosure;

FIG. 2 is a diagram of a cleaning utensil that provides an alternate view; and

FIG. 3 is a side view diagram of a cleaning utensil.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

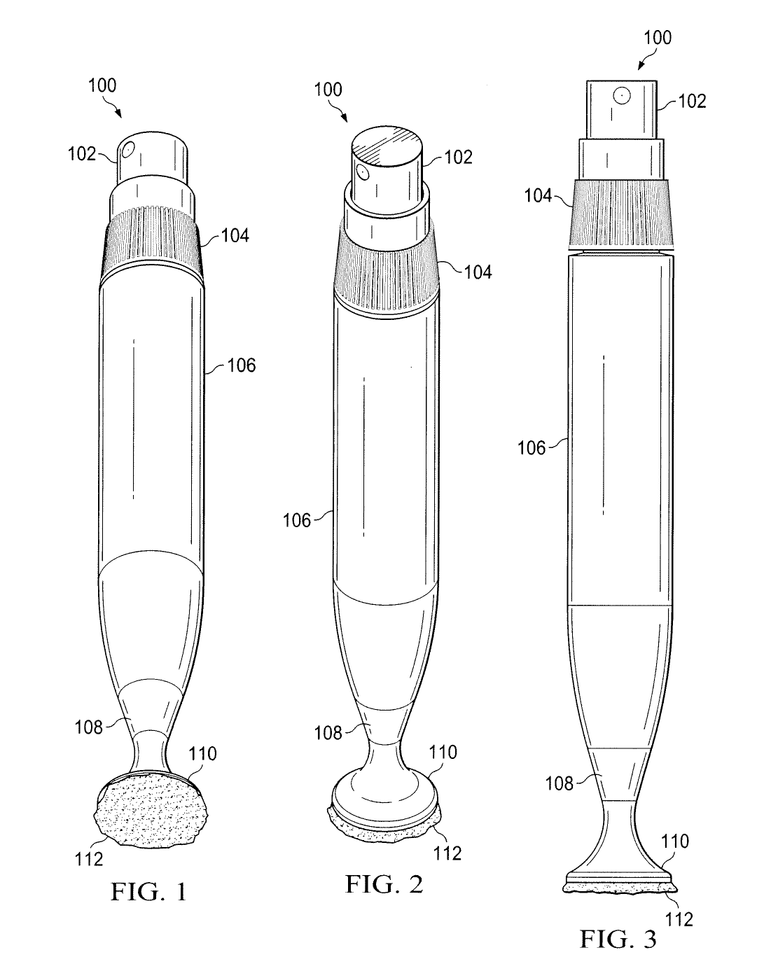

FIG. 1 is a diagram of a cleaning utensil 100 in accordance with an exemplary embodiment of the present disclosure. Cleaning utensil 100 includes spray nozzle 102, which can be a pump atomizer, a pressure release atomizer or other suitable spray nozzles. In one exemplary embodiment, spray nozzle 102 can include a cover that snaps or screws on to the housing adjacent to spray nozzle 102. In another exemplary embodiment, spray nozzle 102 can be locked by rotating spray nozzle 102 clockwise or counterclockwise, such as to engage opposing threads on spray nozzle 102 and cap 104, body 106, or in other suitable manners.

Cleaning utensil 100 includes cap 104, which screws, snaps or otherwise locks into or onto body 106, and which can form a water-tight seal with body 106. Body 106 can include an interior cavity that forms a fluid reservoir for holding a cleaning fluid, such as an alcohol-based cleaning solution, a soap and water solution, or other suitable solutions for cleaning glass lenses, polycarbonate lenses or other materials. In another exemplary embodiment, a pressurized cylinder can be inserted into body 106 and can connect to spray nozzle 102 in a suitable manner, such as by a tube or hose. Other suitable types of fluid reservoirs and delivery mechanisms for cleaning compounds can also or alternatively be used.

Body 106 is connected to grip 108, which is configured to allow a user to firmly hold cleaning utensil 100 so as to allow fabric 112 to be brushed or scrubbed against a surface, such as the surface of an eyeglass lens. Grip 108 can be a separate structure that is attached to body 106, can be formed as a single piece with body 106, can include a rubber layer or other suitable materials that provide a gripping surface, or can be formed in other suitable manners. Grip 108 forms a neck of reducing cross-sectional area from body 106, which can be a cylindrical section or other suitable shapes. Body 106 and other parts of cleaning utensil 102 can be formed from high-impact plastic or other materials that are durable and resistant to damage. Fabric 112 is a fabric material that can be used on eyeglass lenses, such as a cotton cloth or other suitable material, and can be held in position by fabric head 110, which can include one or more locking mechanisms for holding fabric 112. In one exemplary embodiment, fabric head 110 can include a clip that clips onto a sleeve in fabric 112. Likewise, adhesives, Velcro or other suitable materials can also or alternatively be used to secure fabric 112 to fabric head 110.

In operation, cleaning utensil 102 can be used to clean eyeglasses or other suitable objects. First, the user removes the nozzle cover (not explicitly shown), unlocks the nozzle, or otherwise prepares the nozzle for use. The user can then depress nozzle 102 to generate a mist of cleaning fluid, such as by using a pump, by releasing a pressurized cleaning fluid, or in other suitable manners. The cleaning fluid is atomized through nozzle 102, and is directed towards the surface to be cleaned.

Next, the user secures nozzle 102 or replaces the nozzle cover, and holds cleaning utensil 102 by grip 108, to allow the user to brush the moistened surface with fabric 112. In this manner, the moistened surface can be gently scrubbed to remove dirt, dried liquid film, or other soiling materials.

Prior to or after use, the user can also refill the fluid reservoir by unscrewing or otherwise separating cap 104 from body 106 to access a fluid reservoir internal to body 106 (not explicitly shown). The user can also replace fabric 112, such as by releasing a clip attached to fabric head 110, by pulling fabric 112 off a Velcro or adhesive layer that holds fabric 112 to fabric head 110, or in other suitable manners.

FIG. 2 is a diagram of cleaning utensil 100 that provides an alternate view. As shown in FIG. 2, nozzle 102 includes a top surface that can be depressed by the user, to either pump a cleaning fluid through an atomizer, to release a pressurized cleaning fluid, or to perform other suitable functions.

FIG. 3 is a side view diagram of cleaning utensil 100.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A cleaning utensil comprising:
a body having a first end, a second end and an interior cavity;
a cap secured to the first end of the body and forming a water-tight seal against the body;
a nozzle disposed on the cap, wherein the nozzle is configured to dispense a fluid that is stored in the interior cavity of the body;
a grip attached to the second end of the body; and
a fabric head attached to the grip, the fabric head including a mechanism to secure a fabric layer to the fabric head.

2. The cleaning utensil of claim 1 wherein the body is approximately cylindrical.

3. The cleaning utensil of claim 1, further comprising a cylinder disposed in the cavity, the cylinder holding a compressed gas and fluid, and wherein the nozzle is configured to atomize the fluid when depressed.

4. The cleaning utensil of claim 1, further comprising a pump disposed in the cavity, and wherein the nozzle is configured to atomize the fluid when the pump is depressed.

5. The cleaning utensil of claim 1 wherein the grip comprises a layer of material disposed over an extension from the second end of the body, wherein the extension comprises a neck having a decreasing cross-sectional area.

6. The cleaning utensil of claim 1 wherein the mechanism comprises a clip.

7. The cleaning utensil of claim 1 wherein the mechanism comprises Velcro.

8. The cleaning utensil of claim 1 wherein the mechanism comprises an adhesive.

9. The cleaning utensil of claim 1 wherein the nozzle comprises a lock mechanism that is engaged by rotating the nozzle in a clockwise or counterclockwise direction.
